(19) United States
(12) Patent Application Publication
(10) Pub. No.: US 2006/0271636 A1
(43) Pub. Date: Nov. 30, 2006

(54) Push-to-transfer (PTX) content from remote site

(76) Inventor: Senaka Balasuriya, Arlington Heights, IL (US)

Correspondence Address: MOTOROLA INC, 600 NORTH US HIGHWAY 45, ROOM AS437, LIBERTYVILLE, IL, 60048-5343, US

(21) Appl. No.: 11/136,983

(22) Filed: May 25, 2005

(51) Int. Cl. G06F 15/16

(52) U.S. Cl. 709/217

(57) ABSTRACT

A push-to-transfer session server (200) including a content sharing request receiving entity for sharing request receiving entity for receiving a content sharing request from a push-to transfer session participating terminal, a content retrieval entity (220) that obtains content from a location other than from the terminal from which the content sharing request was received, and an entity (250) for sharing the content obtained with a push-to-transfer session participating terminal other than the terminal from which the sharing request was received. In some embodiments the server includes a content storage entity for storing content to be shared with push-to-transfer session participating terminals.

### FIELD OF THE DISCLOSURE

The present disclosure relates generally to wireless communications, and more particularly to push-to-transfer (PTX), for example, PTX-over-cellular (POC) for sharing various types of content including voice, images, files and video, PTX applications and methods.

### BACKGROUND OF THE DISCLOSURE

Push-to-transfer (PTX) is a set of next generation push-to-talk (PTT) applications. Among other applications, PTX includes push-to-view (PTView) and push-to-video (PTVideo). These exemplary PTX applications enable the sharing of pictures/images, streaming video, movie clips, files and other content among PTX session participants. Current PTX architectures however are limited to the transmission of PTX content from participating PTX devices, and more particularly the PTX enabled Mobile Station (MS) holding the floor. For example, when a PTX participant wants to share content, for instance, a movie clip, with other PTX session participants, the sharing occurs when the PTX participant obtains the floor for the content and plays the movie clip at the PTX device. Another example is when the PTX floor holder streams live video content captured by a camera on the PTX device to other PTX session participants. In these and other known PTX architectures, the shared content is distributed directly from or by the floor holding PTX device. Under existing architectures, content originating from a source other than the PTX floor holder device must be first retrieved by the floor holder device before being shared with other PTX session participants.

The various aspects, features and advantages of the disclosure will become more fully apparent to those having ordinary skill in the art upon careful consideration of the following Detailed Description with the accompanying drawings described below.

### BRIEF DESCRIPTION OF THE DRAWINGS

FIG. 1 is an exemplary wireless push-to-transfer architecture.

FIG. 2 is a schematic block diagram of an exemplary push-to-transfer session server.

FIG. 3 is an exemplary push-to-transfer content over a cellular communication network scenario.

FIG. 4 is another exemplary push-to-transfer content over a cellular communication network scenario.

### DETAILED DESCRIPTION

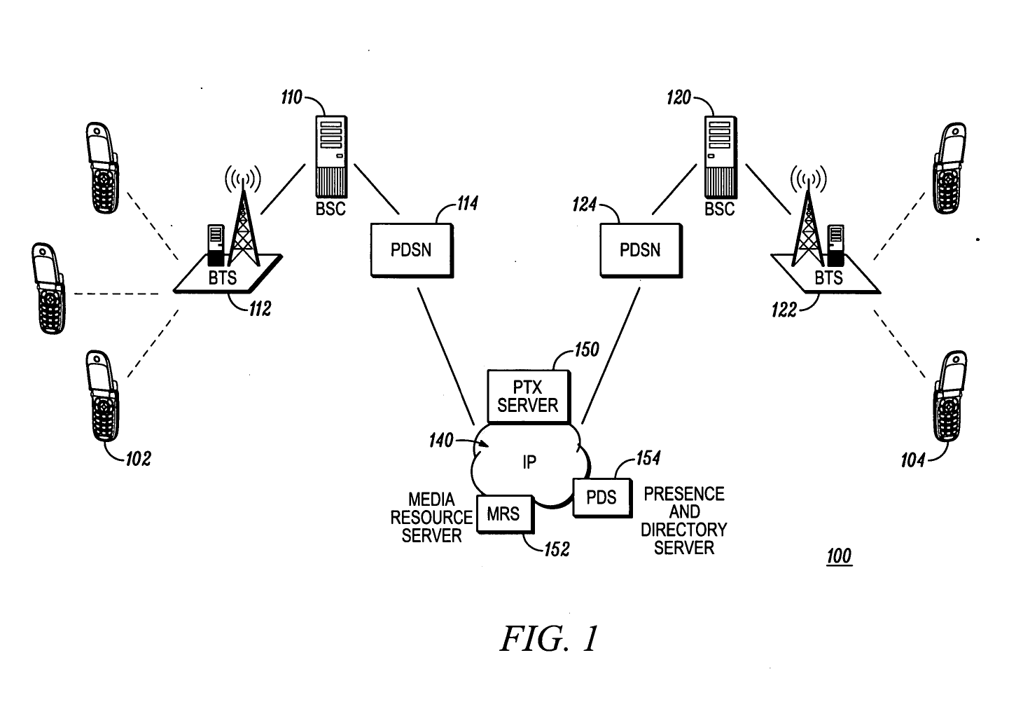

FIG. 1 is an exemplary communication system 100 implementing push/press-to-talk (PTT)/push-to-transfer anything (PTX) over a cellular (PoC) communication network. The terms press/push-to-talk (PTT) and push-to-transfer (PTX) are used interchangeably in the instant specification to mean push to transfer voice, video, data or any other content or information. For example, push-to-video is a particular PTX application. POC refers to PTX over a cellular communication network.

The exemplary system generally comprises one or more base station controllers each of which is communicably coupled to one or more corresponding base transceiver stations. In the system 100 of FIG. 1, base station controller (BSC) 110 is communicably coupled to a base transceiver station (BTS) 112 and base station controller (BSC) 110 is communicably coupled to base transceiver station (BTS) 122. The base station controllers BSC 110 and BSC 120 are both communicably coupled to corresponding packet data serving nodes (PDSN) 114 and PDSN 124, respectively. In FIG. 1, each BSC is communicably coupled to a network, for example, to an IP network 140 like the Internet, by a corresponding PDSN. The exemplary cellular communication network may also be communicably coupled to a public switched telephone network (PSTN) by a mobile switching center (MSC). FIG. 1 also illustrates communication terminals, for example, mobile stations 102 and 104, capable of communicating with one another and/or with entities on other networks over the exemplary wireless communication network.

An exemplary cellular communication network may be, for example, a GSM and/or W-CDMA based 2.5/3^{rd} Generation 3GPP network or a 3GPP2 CDMA communication network, among other existing and future generation cellular communication networks. In these and other cellular communication network implementations, the base station controllers, for example, BSC 110 and BSC 120 in FIG. 1, are typically communicably coupled to a mobile switching center (MSC), which is communicably coupled to a public switched telephone network (PSTN). The network may also include an instant messaging server (IMS). The MSC, PSTN and IMS are not illustrated in the exemplary architecture of FIG. 1 although these entities and the functionality thereof are well known by those having ordinary skill in the art.

While the exemplary communication system of FIG. 1 is a cellular communication network, push-to-transfer (PTX) may also be implemented, more generally, in non-cellular communication networks, including, among others, trunked and wire-line communication network architectures. Thus the present disclosure is not limited push to PTX over cellular (POC) networks.

In FIG. 1, PDSN 114 and PDSN 124 are both communicably coupled to a PTX session server 150 via the network 140. The PTX session server 150 is communicably coupled to the cellular communication network, for example, via an IP Multimedia Sub-system (IMS). In FIG. 1, the PDSN 114 and PDSN 124 are also communicably coupled to a media resource server (MRS) 152 and to a presence and directory server (PDS) 154.

Contemporary push-to-transfer (PTX) over cellular (POC) communication network implementations utilize packet data techniques conforming to formats and protocols defined by industry organizations, including the Internet Engineering Task Force (IETF) and the World Wide Web Consortium (W3C), among others. Exemplary protocols include the Internet Protocol (IP), Transmission Control Protocol (TCP), User Datagram Protocol (UDP), Session Initiation Protocol (SIP), Session Description Protocol (SDP), and the Real Time Streaming Protocol (RTSP), among other protocols. Other standards bodies, including 3GPP, 3GPP2, OMA and the IEEE, define how the packet data information is utilized in conjunction with wireless.and wire-line/fixed networks. In other embodiments, the PTX functionality may be implemented over some other type of communication network using another protocol. In some PTX architectures, the wireless communication devices, for example, terminals 102 and 104 in FIG. 1, operate in a one-half duplex mode during the communication session. In other embodiments, however, the terminals may communicate over a PTX capable communication network in a full duplex mode.

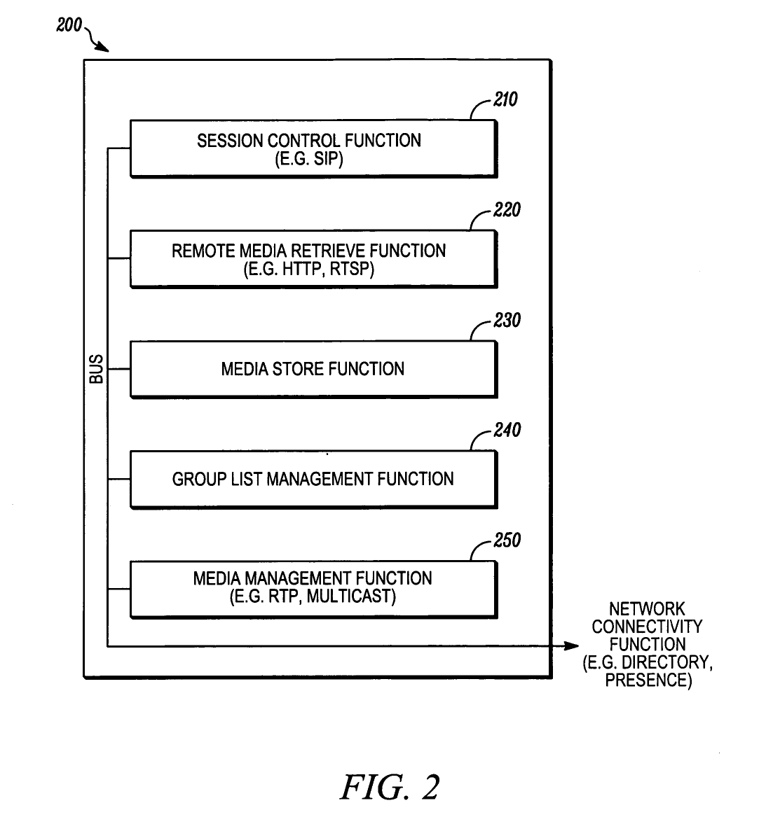

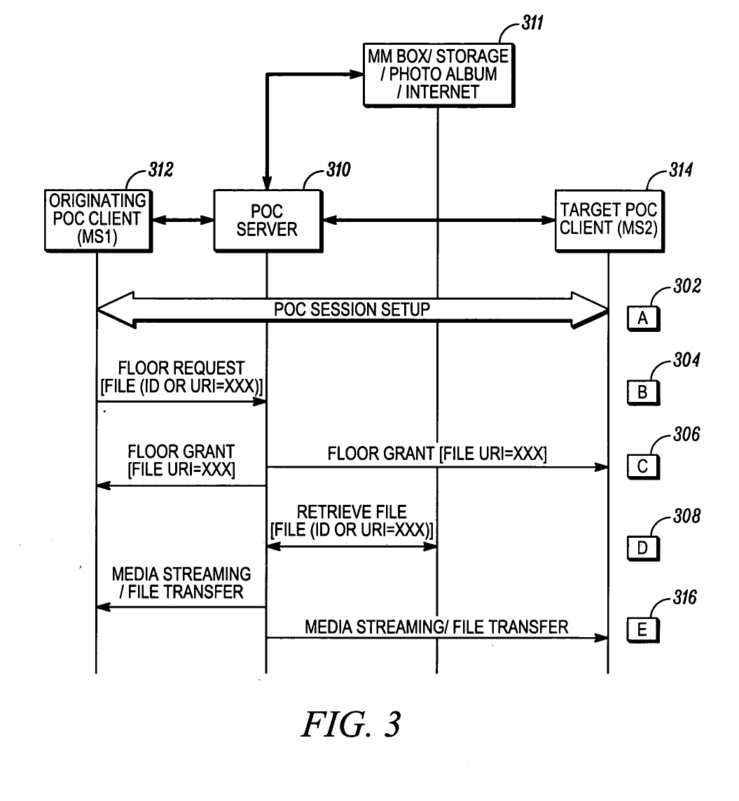

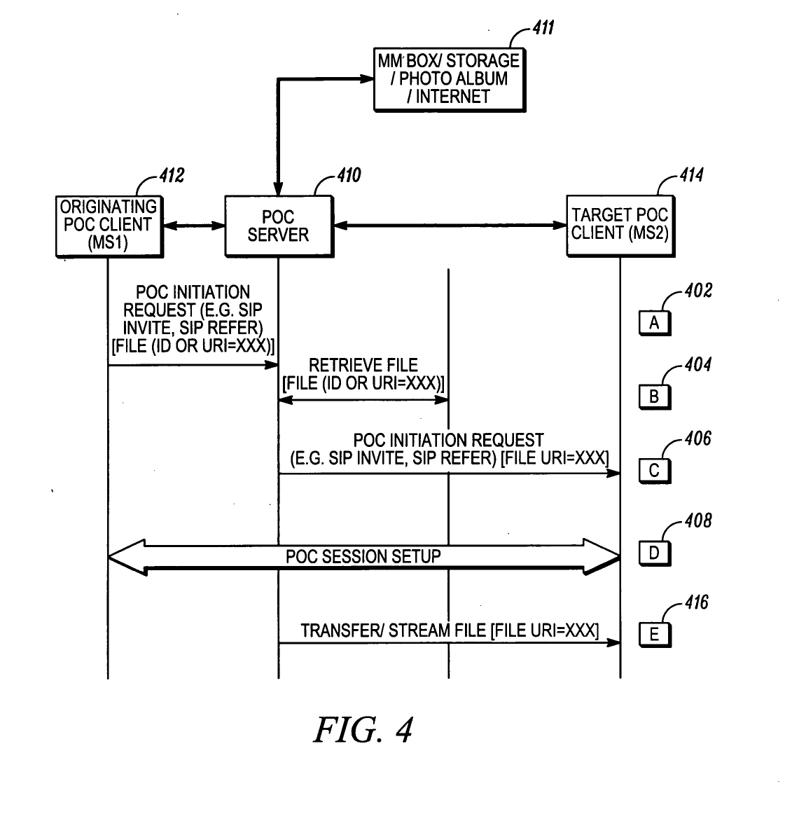

FIG. 2 is an exemplary PTX session server 200 capable of performing both PTX server and session functions. In other embodiments the functionality of the PTX server and the session server are implemented in separate entities. Session servers generally include a content sharing request receiving entity for receiving a content sharing request from a push-to transfer session participating terminal as is known generally. The content sharing request entity can be sent as part of a session setup request, as illustrated in the exemplary scenario of FIG. 4 or as part of a floor control message illustrated in the scenario of FIG. 3, both of which are discussed further below. The request could also be sent separately.

In FIG. 2, the exemplary server 200 comprises a session control entity 210 capable of hosting a PTX session. Exemplary session protocols were discussed above. In FIG. 2, a remote media retrieval entity 220 retrieves content from remote locations, for example, using Hypertext Transfer Protocol (HTTP), Real Time Streaming Protocol (RTSP), among others. The server 200 also includes a media storage entity 230 for storing content, a group list management entity 240 for managing PTX sessions, and a media management entity 250 for managing the communication of media. The server also includes generally a processor for controlling the various entities and the functions thereof, for example, based on the execution of a program or other instructions stored in memory. These and other aspects of the server are discussed further below.

According to one aspect of the disclosure, a terminal in a push-to-transfer (PTX) session with one or more other terminals sends a PTX request to a push-to-transfer server or other entity hosting the PTX session. The push-to-transfer request includes information identifying information that should be provided by the PTX session server to at least one other PTX terminal in the PTX session. The PTX session server then sends the information, e.g., content, to the other PTX session participant(s) or terminal(s) on behalf of the terminal that sent the PTX request. In some embodiments, the PTX session server also sends the content to the terminal that sent the PTX request. Some examples are discussed below.

In an exemplary push-to-video (PTVideo) session embodiment, a PTX session participant, referred to as a PTX requester, wants to share a movie clip among other participants in the PTX session. In one exemplary embodiment, the movie clip is not in the PTX requester's device. The movie clip is however available at some other location, for example, at a remote world wide web site. According to this exemplary embodiment, the PTX requester, requests/obtains the floor and instructs the PTX session server to retrieve the content from the other location and to stream the content to the session participants. In some embodiments, the video clip is also streamed to the PTX requester initiating the request. Alternatively, the PTX session server could provide the session participants with a link to the video clip or other remote location, so that the PTX participants can access the video clip or other content directly. The retrieval of content, for example, from an online photo album, may be performed by entity 220 in FIG. 2, by providing a direct link to content. The link may be stored locally at the session or PTX server, for example at the storage entity 230 in FIG. 2. Alternatively, the PTX session server could retrieve the content from the online photo album, store it locally, for example, in the media storage entity 230 in FIG. 2, and then provide the session participants with a link to local storage so that the PTX participants can access the content directly. In another embodiment, the PTX session server could retrieve a session link from the online photo album, and provide the session participants with a link so that the PTX participants can access the content directly. In some embodiments, the PTX server, for example, the media management entity 250 in FIG. 2, may obtain or assign a multicast address for sharing the content, notify the session participants of the multicast address, and share the contents via multicast.

In an exemplary push-to-view (PTView) session embodiment, a PTX session participant (PTX requester) wants to share still image information from another source, for example, a picture from an online photo album, among other participants in a PTX session. The exemplary online photo album may be provided by a network provider, for example, from a wireless service provider's Multimedia Messaging Service (MMS) MultiMedia box (MMB). According to this exemplary embodiment, the PTX requester requests/obtains the floor and instructs the PTX session server to retrieve the content from the other location, for example, to retrieve a designated picture from an online photo album and stream it to the PTView session. The PTX session server, for example, the remote media retrieval entity 220 in FIG. 1, retrieves the picture from the network operator's online photo album of the PTX requester and then transfers the file to the participants in the PTX session. Alternatively, the PTX session server could provide the session participants with a link to the online photo album or other remote location so that the PTX participants can access the picture or other content directly. In FIG. 2, the link is provided by entity 220. Alternatively, the PTX session server could retrieve the content from the online photo album, store it locally, and provide the session participants with a link to a local storage entity so that the PTX participants can access the content directly. In another alternative embodiment, the PTX session server could retrieve a session link from the online photo album, and provide the session participants with a link to local storage, for example, in the media storage entity 230 in FIG. 2, so that the PTX participants can access the content directly. In some embodiments, the PTX server may obtain or assign a multicast address for sharing the content, notify the session participants of the multicast address, and then share the content via multicast.

In another exemplary embodiment, a PTX requester wants the PTX server to stream a designated movie clip from a remote location such as a subscription-based movie preview website to all participants in a PTX session. According to this exemplary embodiment, the PTX requester instructs the PTX session server to access the subscription-based movie preview website and to stream a designated movie clip to all the participants in the PTX session. To facilitate this transfer, the PTX requester may send a Universal Resource Indicator (URI) of the movie preview site, the name or URI of the movie clip, username, movie preview website password, cookie information, protocol information, etc., with the request message or have the information pre-provisioned. Alternatively, the PTX session server may forward this information to the session participants so that they may access the movie preview website directly. This information may include connecting to the remote location, logging in, and obtaining a different link, where the remote location may provide a different link for security and other reasons. For example, the PTX server may initiate a Real Time Streaming Protocol (RTSP) session with the remote location to obtain a session link and provide that link to the session participants so that the session participants' terminals may initiate a real time streaming application to receive the content.

In yet another exemplary embodiment, a PTX request for PTView, PTVideo, or some other PTX session embodiment, may or may not be associated with floor control. In other words, it may be advantageous to share a movie/video clip, music file or other content located at a remote location without having to obtain the floor, in which case the PTX request message is used to initiate sharing of content and a PTX release message may be used to terminate sharing of content. When control of the floor is required prior to sharing the content, the PTX requester may become the floor holder and may control when to initiate sharing and when to terminate sharing via the floor control messages. For example, releasing the floor may terminate sharing the content. Alternatively, the content sharing may terminate before the floor is released. Although the PTX requester's terminal is the holder of the floor, content retrieval and sharing is performed by the PTX server or other nodes rather than by the PTX requester's terminal.

In another alternative embodiment, the PTX server, upon receiving a PTX request from a PTX session participant, obtains a multicast address through which to share content, and notifies the PTX session participants that content will be shared. The PTX server then retrieves the content from the remote location and shares the content via multicast.

Generally, the push-to-transfer session participating terminal, for example, one of the terminals 102 and 104 in FIG. 1, sends a transfer PTX request or some other message to the PTX server indicative of the desire to transfer or share something with other PTX session participants. The PTX initiation request includes information identifying content or a link to content that should be provided by the PTX server to other PTX session participants on behalf of the PTX participant initiating the transfer.

FIG. 3 illustrates an exemplary scenario where content, a file or other information is shared via a network-based resource during floor control signaling in an exemplary push-to-transfer (PTX) over cellular (POC) architecture. The exemplary scenario is useful for sharing a movie/video clip, music file or other content located at a remote location during a POC session. In FIG. 2, at step “a” 302, a POC session is set up by a POC server 310 between an originating client-terminal, for example, a wireless mobile station (MS1) 312 and one or more target client-terminals (MS2) 314. After the PTX session is established, MS1 312 decides to send or stream a file or content that may or may not be available at MS1 312. At step “b” 204, MS1 312 sends a Floor Request to send a file or stream content. The MS1 312 also sends an indication to the POC server 310 to retrieve a specific file/content and send/stream it. The file or content may be retrieved by the PTX server or by some other entity on behalf of the PTX server. The Floor Request may be combined with either the POC session setup (step “a”) or the indication (step “b”). The indication includes, for example, the identification and location, e.g., URL, of the file/content as well as any authentication information, e.g., username, password, DRM info, certificates, cookies, etc. In FIG. 3, the address is for a server 311, for example, a multimedia box, an online photo album, an Internet address, etc. The indication may be sent as part of the request, or alternatively the indication may be sent separately from the request. At step “c” 306, MS1 312 is granted the floor and both MS1 and MS2 are notified of the floor grant. At this juncture, the server 310 may allocate, directly or indirectly, one or more multicast addresses to multicast the file/content to MS2. At step “d” 208, the server 310 retrieves the file/content identified at step “b”. In some embodiments, the server 310 may perform transcoding, descrambling, storing/buffering, encryption, or other functions to the file/content before sending it to the MS2 314. At step “e” 316, the server 310 transfers/streams the file/content retrieved from the service 311 to MS1 and MS2. If the content already resides on MS1, the requesting device, it may not be necessary for the POC server to re-send it to MS1. Thus in some embodiments, the requesting device may indicate, for example, in the request or other indication, whether or not the POC server should send the content to the originating device. Upon receiving the file/content, it is either saved or played by the recipient.

FIG. 4 illustrates an exemplary scenario where content, a file or other information is shared via a network-based resource during push-to-transfer (PTX) signaling in an exemplary PTX over cellular (POC) architecture. The exemplary scenario is useful, for example, where an incoming call signal includes a picture of the caller/originator or some other information. In FIG. 4, at step “a” 402, an originating terminal (MS1) 412 initiates a PTX session with a Target Client (MS2) 414 via the POC server 410 by sending an Initiation Request, for example, a SIP INVITE to the POC server 410. MS1 412 also sends a picture or other content and includes an indication in the Initiation Request to the POC server to make the content available for the Target POC client for display. The indication includes the ID and location, e.g., URL, of the file/content and possibly other authentication information, for example, e.g., username, password, Digital Rights Management (DRM) information, certificates, cookies, etc. The request and indication steps may be combined or separated. At step “b” 404, the POC server 410 retrieves the file/content indicated in the Initiation Request at 402. The POC server may also perform transcoding, descrambling, encryption and other processing on the file/content as discussed above. At step “c” 406, the POC server 410 forwards the Initiation Request to MS2 414. This message may include the file/content, or as depicted in step “e” 418, include a link to the file/content so that MS2 414 can retrieve the file/content directly from the source, for example, from service 411. At step 408, the POC session is setup and MS1 412 is granted the floor. If MS2 didn't get the file/content streamed in the Initiation Request but received a link to the file/content, MS2 fetches the file/content from the server or other source.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a push-to-transfer session server, the method comprising:
receiving a request from a push-to-transfer session terminal to share content with another push-to-transfer session terminal;
obtaining the content from a location other than from the terminal from which the request is received;
sharing the content obtained by the push-to-transfer server with the other push-to-transfer session terminal.

2. The method of claim 1,
receiving the request from a push-to-transfer session terminal to share content with another push-to-transfer session terminal when the terminal from which the request was received holds a push-to-transfer session floor.

3. The method of claim 2, sharing the content with the terminal from which the request was received.

4. The method of claim 1, receiving the request includes receiving at least one of information identifying the content to be shared and information identifying the location of the content to be shared.

5. The method of claim 1, receiving the request with a push-to-transfer session floor request from the terminal from which the request was received.

6. The method of claim 5,
granting the push-to-transfer session floor to the terminal from which the request was received,
sharing the content obtained by the push-to-transfer server with the other push-to-transfer session terminal after granting the floor to the terminal from which the request was received.

7. The method of claim 1, receiving the request with a push-to-transfer session initiation request.

8. The method of claim 7,
establishing the push-to-transfer session in response to receiving the request,
sharing the content obtained by the push-to-transfer server with the other push-to-transfer session terminal after establishing the push-to-transfer session.

9. The method of claim 7,
sending a push-to-transfer session initiation request to the other push-to-transfer session terminal after receiving the request,
sharing the content includes sharing the content with the push-to-transfer session initiation request sent to the other push-to-transfer terminal.

10. The method of claim 7,
obtaining the content from a location other than from the terminal from which the request is received includes obtaining a link to the content,
sharing the content includes one of
sending the link to the other push-to-transfer session terminal with the initiation request sent to the other push-to-transfer terminal, and
sending the link to the other push-to-transfer session terminal after establishing the push-to-transfer session.

11. The method of claim 1,
obtaining the content to be shared from a location other than the push-to-transfer server based on information in the request before sharing the content with the other push-to-transfer session terminals.

12. The method of claim 1, sharing the content includes determining at least one multicast address to share the content and sharing the content via multicast.

13. The method of claim 1,
obtaining the content from a location other than from the terminal from which the request is received includes obtaining a link to the content,
sharing the content includes sharing the link obtained by the push-to-transfer server with the other push-to-transfer session terminal.

14. The method of claim 1,
setting up a push-to-transfer session before receiving the request, and
providing a floor grant to the terminal from which the request was received before obtaining the content.

15. The method of claim 1,
sending the request to another push-to-transfer session terminal after obtaining the content,
setting up a push-to-transfer session after sending the initiation request, and
sharing the content after setting up the push-to-transfer session.

16. A method in a push-to-transfer session participating terminal, the method comprising:
sending a push-to-transfer initiation request to a push-to-transfer server,
the push-to-transfer initiation request including information identifying information that should be provided by the push-to-transfer server to at least one other push-to-transfer session participating terminal.

17. The method of claim 16,
sending the push-to-transfer initiation request to the push-to-transfer server,
the push-to-transfer initiation request including information identifying one of:
content at a location other than the terminal sending the initiation request that should be provided by the push-to-transfer server to the at least one other push-to-transfer session participating terminal, and a link to content that should be provided to the at least one other push-to-transfer session participating terminal.

18. A push-to-transfer session server, comprising:
a content sharing request receiving entity, the content sharing request receiving entity for receiving a content sharing request from a push-to transfer session participating terminal;
a content retrieval entity that obtains content from a location other than from the terminal from which the content sharing request was received;
an entity for sharing the content obtained with a push-to-transfer session participating terminal other than the terminal from which the sharing request was received.

19. The server of claim 18, further comprising a content storage entity for storing content to be shared with the push-to-transfer session participating terminal other than the terminal from which the sharing request was received.

20. The server of claim 18, further comprising a media management entity sharing the content with push-to-transfer session participating terminals other than the terminal from which the sharing request was received.
